(19) United States
(12) Patent Application Publication
(10) Pub. No.: US 2015/0350262 A1
(43) Pub. Date: Dec. 3, 2015

(54) CAUSATION OF ESTABLISHMENT OF A LOCATION SHARING GROUP

(71) Applicant: Nokia Corporation, Espoo (FI)

(72) Inventors: Roope Rainisto, Helsinki (FI); Shachindra Dass, Helsinki (FI)

(21) Appl. No.: 14/293,880

(22) Filed: Jun. 2, 2014

(51) Int. Cl. H04L 29/06; H04L 12/26; H04L 29/12

(52) U.S. Cl. CPC H04L 65/403; H04L 61/609; H04L 43/16

(57) ABSTRACT

A method comprising determining at least one separate apparatus property of a separate apparatus, determining that the separate apparatus property satisfies a location sharing group inclusion criteria, causing establishment of a location sharing group that includes the separate apparatus based, at least in part, on the determination that the separate apparatus property satisfies the location sharing group inclusion criteria, and causing communication of location information with the separate apparatus based, at least in part, on the location sharing group is disclosed.

### TECHNICAL FIELD

The technical field relates generally to causation of establishment of a location sharing group.

### BACKGROUND

Over the years, electronic apparatuses have become increasingly prevalent in our society. As a result, many users of electronic apparatuses have become increasingly reliant upon their electronic apparatuses for purposes relating to mapping, navigation, routing, etc. As such, it may be desirable to configure an electronic apparatus such that a user of the electronic apparatus may utilize the electronic apparatus for such purposes easily and intuitively.

### SUMMARY

One or more embodiments may provide an apparatus, a computer readable medium, a non-transitory computer readable medium, a computer program product, and/or a method for determining at least one separate apparatus property of a separate apparatus, determining that the separate apparatus property satisfies a location sharing group inclusion criteria, causing establishment of a location sharing group that includes the separate apparatus based, at least in part, on the determination that the separate apparatus property satisfies the location sharing group inclusion criteria, and causing communication of location information with the separate apparatus based, at least in part, on the location sharing group.

One or more embodiments may provide an apparatus, a computer readable medium, a computer program product, and/or a non-transitory computer readable medium having means for determining at least one separate apparatus property of a separate apparatus, means for determining that the separate apparatus property satisfies a location sharing group inclusion criteria, means for causing establishment of a location sharing group that includes the separate apparatus based, at least in part, on the determination that the separate apparatus property satisfies the location sharing group inclusion criteria, and means for causing communication of location information with the separate apparatus based, at least in part, on the location sharing group.

One or more example embodiments further perform determination of apparatus location information that indicates a location of the apparatus, wherein the causation of communication of location information with the separate apparatus comprises sending of the apparatus location information to the separate apparatus.

In at least one example embodiment, the causation of communication of location information with the separate apparatus comprises receipt of location information from the separate apparatus.

In at least one example embodiment, the causation of communication of location information with the separate apparatus comprises sending of location information to the separate apparatus, and receipt of location information from the separate apparatus.

One or more example embodiments further perform determination of other apparatus location information that indicates a location of another separate apparatus, wherein the causation of communication of location information with the separate apparatus comprises sending of the other apparatus location information to the separate apparatus.

One or more example embodiments further perform receipt of other apparatus location information that indicates a location of another separate apparatus, wherein the causation of communication of location information with the separate apparatus comprises sending of the other apparatus location information to the separate apparatus.

In at least one example embodiment, the determination of the separate apparatus property comprises receipt of information indicative of the separate apparatus property from the separate apparatus.

In at least one example embodiment, the separate apparatus property is one of a separate apparatus identity that identifies the separate apparatus, a user identity that identifies a user of the separate apparatus, separate apparatus location information that identifies a location of the separate apparatus, or separate apparatus proximity information.

In at least one example embodiment, the separate apparatus proximity information indicates whether the separate apparatus is proximate to the apparatus.

In at least one example embodiment, the separate apparatus proximity information indicates whether the separate apparatus is proximate to another separate apparatus.

In at least one example embodiment, the location sharing group inclusion criteria comprises at least one of a separate apparatus property criteria, a durational criteria, or a location criteria.

In at least one example embodiment, the separate apparatus property criteria comprises at least one of a separate apparatus proximity criteria or a social relationship criteria.

In at least one example embodiment, the location sharing group inclusion criteria comprises a separate apparatus property criteria, and the determination that the separate apparatus property satisfies the location group sharing criteria comprises determination that the separate apparatus property satisfies the separate apparatus property criteria.

One or more example embodiments further perform receipt of information indicative of a separate apparatus identity that identifies the separate apparatus, wherein the determination of the separate apparatus property is based, at least in part, on the separate apparatus identity.

In at least one example embodiment, the determination of the separate apparatus property comprises determination of a user identity based, at least in part, on the separate apparatus identity, wherein the determination of the separate apparatus property is based, at least in part, on the user identity.

One or more example embodiments further perform receipt of information indicative of a user identity that identifies a user of the separate apparatus, wherein the determination of the separate apparatus property is based, at least in part, on the user identity.

In at least one example embodiment, the separate apparatus property is a social relationship property, and the determination of the separate apparatus property comprises determination of the social relationship property based, at least in part, on the separate apparatus identity.

In at least one example embodiment, the separate apparatus property criteria comprises a social relationship criteria, and the determination that the separate apparatus property satisfies the separate apparatus property criteria comprises determination that the social relationship property satisfies the social relationship criteria.

In at least one example embodiment, the social relationship property indicates a social relationship distance, the social relationship criteria indicates a social relationship distance threshold, and the determination that the social relationship property satisfies the social relationship criteria comprises determination that the social relationship distance is within the social relationship distance threshold.

One or more example embodiments further perform receipt of separate apparatus location information that identifies a location of the separate apparatus, wherein the determination of the separate apparatus property is based, at least in part, on the separate apparatus location information.

In at least one example embodiment, the determination of the separate apparatus property comprises determination of separate apparatus proximity information based, at least in part, on the separate apparatus location information, wherein the determination of the separate apparatus property is based, at least in part, on the separate apparatus proximity information.

One or more example embodiments further perform receipt of separate apparatus proximity information, wherein the determination of the separate apparatus property is based, at least in part, on the separate apparatus proximity information.

In at least one example embodiment, the separate apparatus property criteria comprises a separate apparatus proximity criteria, and the determination that the separate apparatus property satisfies the separate apparatus property criteria comprises determination that the separate apparatus proximity information satisfies the separate apparatus proximity criteria.

In at least one example embodiment, the separate apparatus proximity criteria comprises a proximity-based communication availability criteria, and the separate apparatus proximity information comprises information indicative of proximity-based communication availability, and the determination that the separate apparatus property satisfies the separate apparatus property criteria comprises determination that the information indicative of proximity-based communication availability corresponds with the proximity-based communication availability criteria.

In at least one example embodiment, the proximity-based communication availability criteria designates availability of a proximity-based communication channel between the separate apparatus and another separate apparatus.

In at least one example embodiment, the proximity-based communication availability criteria designates availability of a proximity-based communication channel between the separate apparatus and the apparatus.

In at least one example embodiment, the information indicative of proximity-based communication availability indicates whether a proximity-based communication channel exists between the separate apparatus and another separate apparatus.

In at least one example embodiment, the information indicative of proximity-based communication availability indicates whether a proximity-based communication channel exists between the separate apparatus and the apparatus.

In at least one example embodiment, the determination that the information indicative of proximity-based communication availability corresponds with the proximity-based communication availability criteria comprises determination that the proximity-based communication channel designated by the proximity-based communication availability criteria corresponds with the proximity-based communication channel indicated by the information indicative of the proximity-based communication availability.

One or more example embodiments further perform receipt of separate apparatus location information that identifies a location of the separate apparatus, wherein the location sharing group inclusion criteria comprises a location criteria and a separate apparatus property criteria, and the determination that the separate apparatus property satisfies the location group criteria comprises determination that the separate apparatus property satisfies the separate apparatus property criteria and determination that a location associated with the location criteria is within a location distance threshold from the location of the separate apparatus.

In at least one example embodiment, the location sharing group inclusion criteria comprises a durational criteria and a separate apparatus property criteria, and the determination that the separate apparatus property satisfies the location group criteria comprises determination that the separate apparatus property satisfies the separate apparatus property criteria, and determination that a threshold duration associated with the durational criteria has elapsed subsequent to the determination that the separate apparatus property satisfies the separate apparatus property criteria.

In at least one example embodiment, the determination that the threshold duration has elapsed subsequent to the determination that the separate apparatus property satisfies the separate apparatus property criteria comprises determination that the threshold duration has elapsed subsequent to the determination that the separate apparatus property satisfies the separate apparatus property criteria absent a determination that the separate apparatus property has changed in a manner that causes the separate apparatus property to fail to satisfy the separate apparatus criteria.

One or more example embodiments further perform sending of a location sharing group invitation to the separate apparatus based, at least in part, on the determination that the separate apparatus property satisfies the location sharing group inclusion criteria, and receipt of a location sharing group acceptance from the separate apparatus, wherein the causation of establishment of the location sharing group that includes the separate apparatus is based, at least in part, on the receipt of the location sharing group acceptance from the separate apparatus.

One or more example embodiments further perform receipt of information indicative of a location sharing group exclusion request from the separate apparatus, and causation of modification of the location sharing group such that the location sharing group fails to include the separate apparatus based, at least in part, on the location sharing group exclusion request.

One or more example embodiments further perform receipt of information indicative of a location sharing group exclusion request from the separate apparatus, and causation of modification of the location sharing group such that the location sharing group excludes the separate apparatus based, at least in part, on the location sharing group exclusion request.

One or more example embodiments further perform determination of at least one other separate apparatus property of another separate apparatus, determination that the other separate apparatus property satisfies the location sharing group inclusion criteria, causation of modification of the location sharing group such that the location sharing group includes the other separate apparatus based, at least in part, on the determination that the other separate apparatus property satisfies the location sharing group inclusion criteria, and causation of communication of location information with the other separate apparatus based, at least in part, on the location sharing group.

One or more example embodiments further perform determination of at least one other separate apparatus property of another separate apparatus, determination that the other separate apparatus property fails to satisfy the location sharing group inclusion criteria, and preclusion of modification of the location sharing group such that the location sharing group includes the other separate apparatus based, at least in part, on the determination that the other separate apparatus property fails to satisfy the location sharing group inclusion criteria.

One or more example embodiments further perform preclusion of communication of location information with the other separate apparatus based, at least in part, on the location sharing group.

One or more example embodiments further perform determination of at least one other separate apparatus property of another separate apparatus, determination that the other separate apparatus property fails to satisfy the location sharing group inclusion criteria, and causation of modification of the location sharing group such that the location sharing group excludes the other separate apparatus based, at least in part, on the determination that the other separate apparatus property fails to satisfy the location sharing group inclusion criteria.

One or more example embodiments further perform determination that the separate apparatus property no longer satisfies the location sharing group inclusion criteria, and causation of modification of the location sharing group such that the location sharing group fails to include the separate apparatus based, at least in part, on the determination that the separate apparatus property fails to satisfy the location sharing group inclusion criteria.

One or more example embodiments further perform determination that the separate apparatus property no longer satisfies the location sharing group inclusion criteria, and causation of modification of the location sharing group such that the location sharing group excludes the separate apparatus based, at least in part, on the determination that the separate apparatus property fails to satisfy the location sharing group inclusion criteria.

One or more example embodiments further perform preclusion of communication of location information with the separate apparatus based, at least in part, on the location sharing group.

One or more example embodiments further perform determination that the separate apparatus property satisfies a location sharing group exclusion criteria, and causation of modification of the location sharing group such that the location sharing group fails to include the separate apparatus based, at least in part, on the determination that the separate apparatus property satisfies the location sharing group exclusion criteria.

One or more example embodiments further perform determination that the separate apparatus property satisfies a location sharing group exclusion criteria, and causation of modification of the location sharing group such that the location sharing group excludes the separate apparatus based, at least in part, on the determination that the separate apparatus property satisfies the location sharing group exclusion criteria.

One or more example embodiments further perform preclusion of communication of location information with the separate apparatus based, at least in part, on the location sharing group.

In at least one example embodiment, the location sharing group exclusion criteria comprises at least one of a separate apparatus property criteria, a durational criteria, or a location criteria.

In at least one example embodiment, the separate apparatus property criteria comprises at least one of a separate apparatus proximity criteria or a social relationship criteria.

In at least one example embodiment, the causation of establishment of the location sharing group comprises causation of storage of information indicative of the separate apparatus in a location sharing group data structure, wherein the information indicative of the separate apparatus enables communication of location information with the separate apparatus.

In at least one example embodiment, the information indicative of the separate apparatus is at least one of an identity of the separate apparatus, an address of the separate apparatus, a handle of the separate apparatus, a communication identifier of the separate apparatus, or a communication address of the separate apparatus.

In at least one example embodiment, the causation of storage of information indicative of the separate apparatus in the location sharing group data structure comprises storage of the information indicative of the separate apparatus in at least one of a repository, a database, or a memory.

In at least one example embodiment, the causation of storage of information indicative of the separate apparatus in the location sharing group data structure comprises sending of the information indicative of the separate apparatus to a different separate apparatus such that the different separate apparatus stores the information indicative of the separate apparatus in the location sharing group data structure.

In at least one example embodiment, the location sharing group including the separate apparatus is associated with the location sharing group data structure comprising information indicative of the separate apparatus.

In at least one example embodiment, the location sharing group excluding the separate apparatus is associated with the location sharing group data structure failing to comprise information indicative of the separate apparatus.

In at least one example embodiment, the causation of modification of the location sharing group to exclude the separate apparatus comprises removal of the information indicative of the separate apparatus from the location sharing group data structure.

In at least one example embodiment, the causation of modification of the location sharing group to include the separate apparatus comprises storage of information indicative of the separate apparatus in the location sharing group data structure.

Although various aspects of embodiments are set out in the claims, the summary, and the description, other aspects of the embodiments comprise other combinations of features from other described embodiments. In this manner, the embodiments include the combinations explicitly set out in the claims, the summary, and the description, as well as any other suitable combinations of any suitable features.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIGS. 2A-2B are diagrams illustrating apparatus communication according to at least one example embodiment;

FIGS. 3A-3C are diagrams illustrating a location sharing group according to at least one example embodiment;

FIGS. 4A-4B are diagrams illustrating a location sharing group data structure according to at least one example embodiment;

FIG. 5 is a flow diagram illustrating activities associated with causation of communication of location information with a separate apparatus according to at least one example embodiment;

FIG. 6 is a flow diagram illustrating activities associated with determination of whether a separate apparatus property satisfies a location sharing group inclusion criteria according to at least one example embodiment;

FIG. 7 is a flow diagram illustrating activities associated with causation of communication of location information with a separate apparatus according to at least one example embodiment;

FIG. 8 is a flow diagram illustrating activities associated with causation of communication of location information with a separate apparatus according to at least one example embodiment;

FIG. 9 is a flow diagram illustrating activities associated with causation of communication of location information with a separate apparatus according to at least one example embodiment;

FIG. 10 is a flow diagram illustrating activities associated with causation of communication of location information with at least one of a separate apparatus or another separate apparatus according to at least one example embodiment; and

FIG. 11 is a flow diagram illustrating activities associated with preclusion of communication of location information with a separate apparatus according to at least one example embodiment.

### DETAILED DESCRIPTION OF THE DRAWINGS

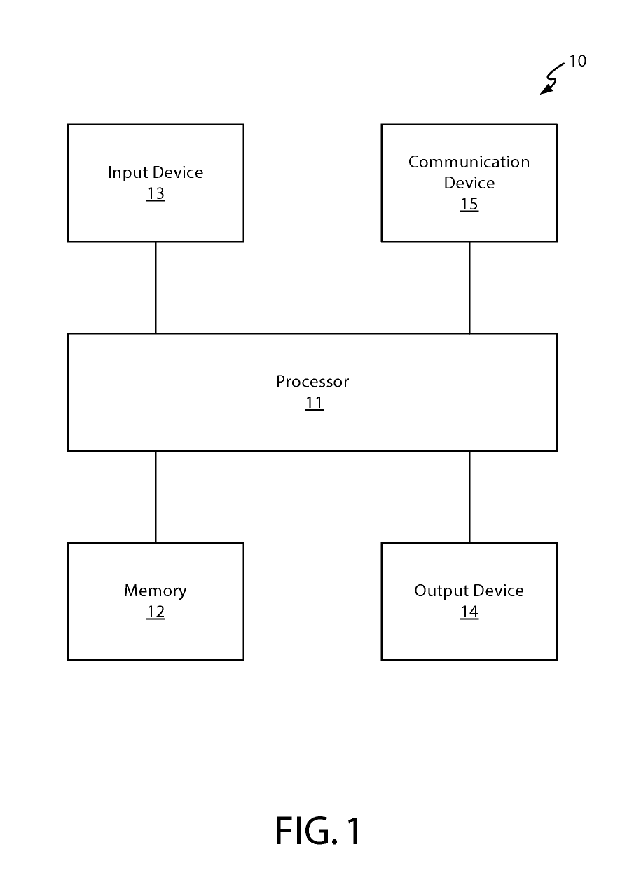

An embodiment of the invention and its potential advantages are understood by referring to FIGS. 1 through 11 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

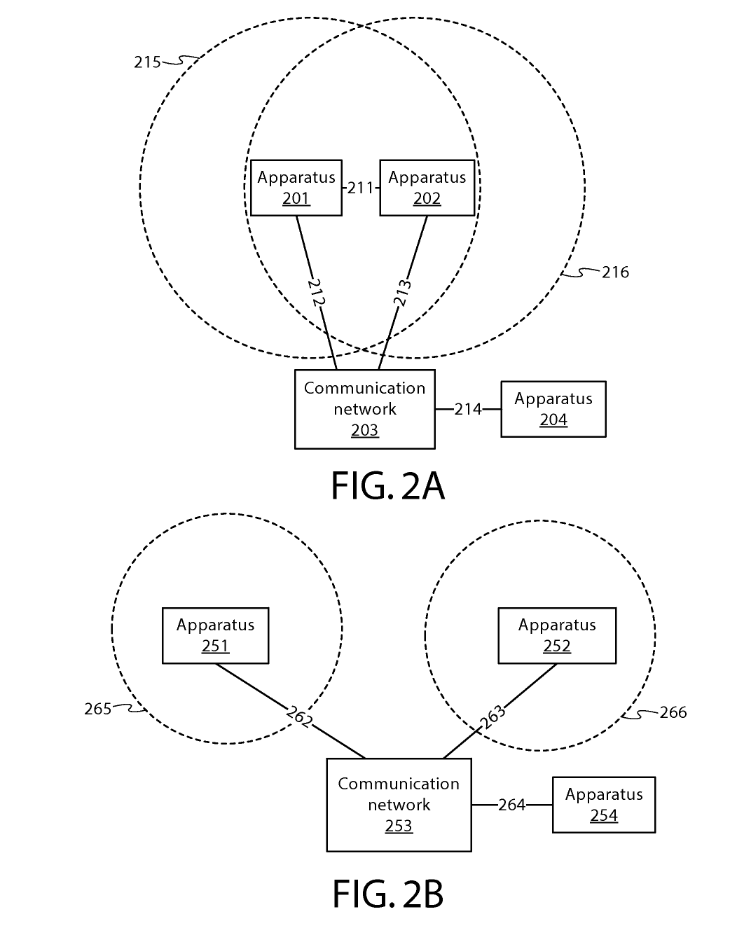

FIGS. 2A-2B are diagrams illustrating apparatus communication according to at least one example embodiment. The examples of FIGS. 2A-2B are merely examples of apparatus communication, and do not limit the scope of the claims. For example, proximity of the apparatuses may vary, type of communication may vary, communication path between apparatuses may vary, and/or the like.

As electronic apparatuses have become more prolific, there has been an increasing desire for collaborative communication between users' electronic apparatuses. For example, a user may have an electronic apparatus and another user may have another electronic apparatus. In such an example, the user and the other user may desire to share information from the electronic apparatus to the other electronic apparatus, to communicate information between the electronic apparatus and the other electronic apparatus, and/or the like. For example, the user may desire to communicate information regarding the separate apparatus, the user of the separate apparatus, a location of the user of the electronic apparatus, a location of the electronic apparatus, and/or the like, to the other electronic apparatus.

In some circumstances, a user may desire to have communication between apparatuses based on their proximity with each other. For example, a user may desire to that the user's electronic apparatus receive communications from separate electronic apparatuses that are local to the electronic apparatus, proximate to the electronic apparatus, and/or the like. A plurality of apparatuses may be proximate to each other based on location, availability of local communication among the apparatuses, and/or the like. For example, if the apparatuses communicate by way of near field communication, Bluetooth, infrared, local area network, wireless local area network, and/or the like, the apparatuses may be considered to be proximate with each other based, at least in part, on availability of such proximity-based communication with each other.

In at least one example embodiment, an apparatus comprises information associated with communicating with a separate apparatus. In at least one example embodiment, communication based, at least in part, on short range communication is referred to as proximity-based communication. In at least one example embodiment, proximity-based communication is wireless communication that is associated with a short range, such as near field communication, Bluetooth, infrared, and/or the like. In such an example the exchange of information may be by way of the short range wireless communication between the apparatus and the separate apparatus.

In some circumstances, proximity-based communication may be associated with communication between apparatuses using a short range communication channel. In some circumstances, proximity-based communication may be associated with to communication between apparatuses using a communication channel that is not necessarily a short range communication channel. In such circumstances, the utilization of the communication channel may be predicated upon availability of a short range communication channel. For example, an apparatus may utilize a short range communication channel to obtain information associated with communication across a different communication channel. For example, an apparatus may utilize short range communication with a separate apparatus to obtain address information for the separate apparatus. In such an example, the apparatus may utilize the address information to communicate with the separate apparatus by way of a different communication channel, such as a different short range communication channel, a communication channel that is not a short range communication channel, and/or the like. In at least one example embodiment, a communication channel is associated, at least partially, with allocation of communication resources between an apparatus and a separate apparatus. For example, a communication channel may be a frequency designation, a channel designation, a sub-channel designation, a frame designation, and/or the like. An apparatus may have a plurality of communication channels. For example, an apparatus may have one or more communication channels with one or more separate apparatuses, with one or more communication networks, and/or the like. For purposes of clarity, a communication channel may be referred to in terms of an apparatus involved in the communication channel. For example, a communication channel associated with an apparatus may be referred to as an apparatus communication channel, a communication channel associated with a separate apparatus may be referred to as a separate apparatus communication channel, a communication channel associated with a communication network may be referred to as a communication network communication channel, and/or the like.

In at least one example embodiment, an apparatus may be involved in establishment of a communication channel. For example, there may be various actions that an apparatus may take for a communication channel to become existent between the apparatus and a separate apparatus, a communication network, and/or the like. After a communication channel is established, the communication channel may be utilized for communication. In at least one example embodiment, an apparatus may be involved in termination of a communication channel. For example, there may be various actions that an apparatus may take for a communication channel to become non-existent between the apparatus and a separate apparatus, a communication network, and/or the like. After a communication channel is terminated, the communication channel may be unavailable for communication. In at least one example embodiment, existence of a communication channel between an apparatus and a separate apparatus is indicative of the apparatus being in communication with the other apparatus.

In at least one example embodiment, an apparatus receives an indication of availability of proximity-based communication with a separate apparatus. The indication of availability may be information indicating that the separate apparatus is within range of a short range communication, an indication that the separate apparatus is present on a short range communication network, and/or the like. In at least one example embodiment, the apparatus determines that the separate apparatus is unavailable for proximity-based communication by way of absence of information indicative of availability of the proximity-based communication.

In the example of FIG. 2A, apparatus 201 and apparatus 202 may communicate locally. In some circumstances, apparatus 201 and apparatus 202 may communicate directly with each other, such as by way of proximity-based communication, by way of communication channel 211. In the example of FIG. 2A, the proximity-based communication range of apparatus 201 is indicated by region 215 and the proximity-based communication range of apparatus 202 is indicated by region 216. In some circumstances, apparatus 201 may communicate with apparatus 202 by way of communication network 203. For example, communication network 203 may be an intermediary apparatus such that apparatus 201 and apparatus 202 may communicate with each other by way of communication channels 212 and 213, may be a group of apparatuses in communication with each other such that apparatus 201 and apparatus 202 may communicate with each other by way of communication channels 212 and 213, and/or the like. In some circumstances, apparatus 201 may obtain information from apparatus 202, by way of communication channel 211, which allows apparatus 201 to communicate with apparatus 202 by way of communication network 203. In some circumstances, apparatus 201 and/or apparatus 202 may communicate with apparatus 204 by way of communication network 203. For example, communication network 203 may be an intermediary apparatus such that apparatus 201 and apparatus 204 may communicate with each other by way of communication channels 212 and 214, may be a group of apparatuses in communication with each other such that apparatus 201 and apparatus 204 may communicate with each other by way of communication channels 212 and 214, and/or the like. In another example, communication network 203 may be an intermediary apparatus such that apparatus 202 and apparatus 204 may communicate with each other by way of communication channels 212 and 214, may be a group of apparatuses in communication with each other such that apparatus 202 and apparatus 204 may communicate with each other by way of communication channels 213 and 214, and/or the like.

In the example of FIG. 2A apparatus 201 may determine that apparatus 202 is proximate based, at least in part, on availability of proximity-based communication 211, by way of communicating with the same communication apparatus of communication network 203, by way of comparing position information of apparatus 201 and position information of apparatus 202, and/or the like.

In the example of FIG. 2B, apparatus 251 and apparatus 252 may communicate with each other by way of communication network 253. Apparatus 251 may be in communication with communication network 253 by way of communication channel 262. Apparatus 252 may be in communication with communication network 253 by way of communication channel 263. In the example of FIG. 2C, the proximity-based communication range of apparatus 251 is indicated by region 265 and the proximity-based communication range of apparatus 252 is indicated by region 266. It can be seen that apparatus 252 is unavailable for proximity-based communication with apparatus 251. In some circumstances, apparatus 251 may communicate with apparatus 252 by way of communication network 253. In the example of FIG. 2B, apparatus 251 may determine that apparatus 252 is not proximate to apparatus 251 based, at least in part, on unavailability of proximity-based communication with apparatus 252. In some circumstances, apparatus 251 and/or apparatus 252 may communicate with apparatus 254 by way of communication network 253. For example, communication network 253 may be an intermediary apparatus such that apparatus 251 and apparatus 254 may communicate with each other by way of communication channels 262 and 264, may be a group of apparatuses in communication with each other such that apparatus 251 and apparatus 254 may communicate with each other by way of communication channels 262 and 264, and/or the like. In another example, communication network 253 may be an intermediary apparatus such that apparatus 252 and apparatus 254 may communicate with each other by way of communication channels 262 and 264, may be a group of apparatuses in communication with each other such that apparatus 252 and apparatus 254 may communicate with each other by way of communication channels 263 and 264, and/or the like.

In at least one example embodiment, a communication network with associated with one or more apparatuses that provide for communication between an apparatus and a separate apparatus. For example, the communication network may comprise a plurality of communication apparatuses. A communication apparatus may be any apparatus associated with facilitation of communication in a communication network. For example, a communication apparatus may be an access point for the communication network, such as a wireless access point, a cellular base station, a Bluetooth access point, and/or the like. In another example, a communication network apparatus may be an apparatus utilized for communication within the communication network, such as a hub, a router, a switch, and/or the like. In at least one example embodiment, an apparatus may be in communication with a communication network by way of a communication channel with a communication apparatus of the communication network. In at least one example embodiment, an apparatus that does not have a communication channel with a communication apparatus may not be in communication with the communication apparatus. In some circumstances, an apparatus and a separate apparatus may communicate by way of a communication network by way of the same communication apparatus. For example, an apparatus may communicate with a separate apparatus, by way of a cellular network, where the apparatus and the separate apparatus are in communication with the same base station of the cellular network. In such an example, the apparatus and the separate apparatus may be within a region that is covered by the base station.

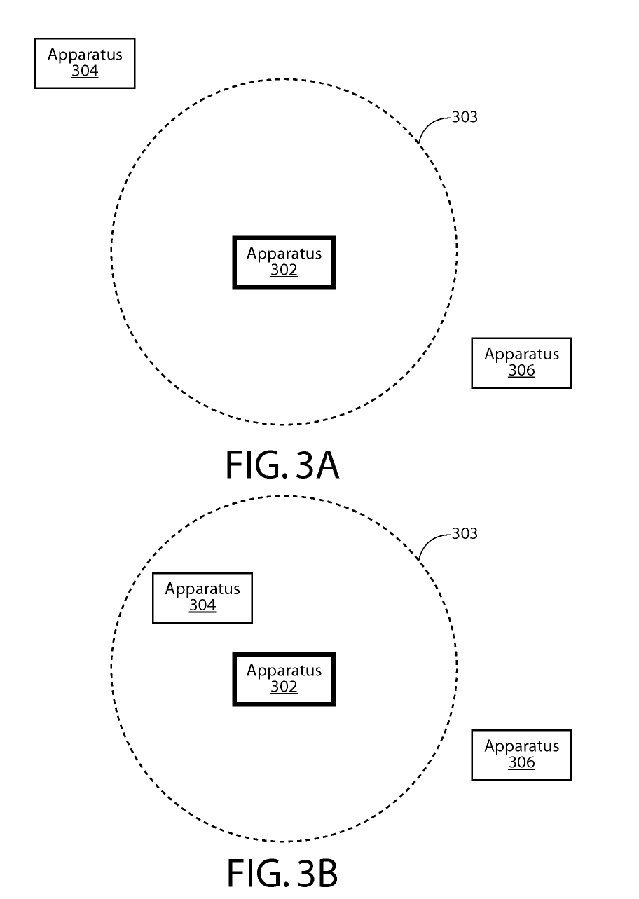

FIGS. 3A-3C are diagrams illustrating a location sharing group according to at least one example embodiment. The examples of FIGS. 3A-3C are merely examples and do not limit the scope of the claims. For example, apparatus configuration may vary, apparatus arrangement may vary, apparatus proximity may vary, and/or the like.

As discussed previously, in many circumstances, it may be desirable to communicate information between electronic apparatuses that may be proximate to each other, near each other, and/or the like. For example, in some circumstances, a user of an electronic apparatus and another user of another electronic apparatus may spend time together. For example, the user and the other user may go out for a night on the town, may embark on a road trip, may go camping and hiking, may go to a music festival, and/or the like. In such an example, the user and the other user may desire to utilize the electronic apparatus and the other electronic apparatus in a manner that allows for communication of location information associated with the electronic apparatus and the other electronic apparatus. For example, the user and/or the other user may desire to be aware of each other's location, keep track of friends such that the user and the other user may find each other if they are momentarily split up, and/or the like. In this manner, the user and the other user may temporarily be made aware of location information associated with the user, the other user, the electronic apparatus, the other electronic apparatus, and/or the like.

In such circumstances, a user may desire to enable sharing of location information and, in other circumstances, may desire to preclude sharing of such location information. For example, the user may desire to share information regarding the location of the user when a given situation is conducive to such sharing, and may desire to avoid sharing of such information when the user has no need to share that information and desires instead to keep the user's location private. In such an example, it may be desirable to avoid complexities associated with manually setting up location sharing services, manually enabling and disabling sharing of such location information, adding contacts with whom to share location information, and/or the like. As such, it may be desirable to allow a user to view such information by way of the user's electronic apparatus in a manner which is easy and intuitive, and which avoids confusion and delay. For example, it may be desirable to establish a location sharing group that includes an electronic apparatus, another electronic apparatus, and/or the like. In such circumstances, it may be desirable to establish the location sharing group based, at least in part, on satisfaction of certain criteria associated with an electronic apparatus, a user of an electronic apparatus, a particular location, and/or the like. As such, the user may be able to utilize information received by way of the location sharing group easily and intuitively.

In order to facilitate such establishment of a location sharing group, it may be desirable to determine one or more attributes of a separate apparatus, properties of the separate apparatus, and/or the like. In at least one example embodiment, an apparatus determines at least one separate apparatus property of a separate apparatus. The separate apparatus property may be a separate apparatus identity that identifies the separate apparatus, a user identity that identifies a user of the separate apparatus, separate apparatus location information that identifies a location of the separate apparatus, separate apparatus proximity information, and/or the like. In such an example embodiment, the separate apparatus property may be any property that facilitates identification of the separate apparatus, identification of a user of the separate apparatus, and/or the like. In at least one example embodiment, the apparatus receives information indicative of a separate apparatus property from a separate apparatus. In such an example, determination of the separate apparatus property may be based, at least in part, on the information indicative of the separate apparatus property received from the separate apparatus. For example, an apparatus may receive information indicative of a separate apparatus identity that identifies a separate apparatus. In such an example, the determination of a separate apparatus property may be based, at least in part, on the separate apparatus identity. In such an example, the apparatus may determine a user identity based, at least in part, on the separate apparatus identity. For example, the apparatus may receive information indicative of the user identity from memory, from a separate apparatus, and/or the like. In such an example, the determination of the separate apparatus property may be based, at least in part, on the user identity. For example, a particular separate apparatus may be commonly utilized by a particular user. In such an example, the apparatus may identify the separate apparatus by way of information indicative of the separate apparatus identity, and may identify the common user of the apparatus by way of information indicative of the user identity that is associated with the particular separate apparatus.

In some circumstances, it may be desirable to share location information when the user is at a particular location. For example, the user may desire to share such location information when the user is at a fair grounds, at a local restaurant, walking through the mall, at an amusement park, and/or the like. When the user is at such locations, the user may desire to share location information associated with the user and the user's electronic apparatus with friends that may also be at the location with them. For example, a user may desire to share location information when the user visiting specific locations, and may desire to avoid sharing location information when the user is visiting different locations. As such, it may be desirable to determine location information that identifies a location of an apparatus, a separate apparatus, and/or the like. In at least one example embodiment, an apparatus receives separate apparatus location information that identifies a location of the separate apparatus. The separate apparatus location information may be received from memory, another separate apparatus, and/or the like. In such an example, the determination of the separate apparatus property may be based, at least in part, on the separate apparatus location information. In some embodiments, the apparatus may also receive separate user activity information from the separate apparatus. The separate user activity information may indicate a current activity of the separate user, such as, for example, “walking”, “running”, or “talking”, which can be determined by one or more sensors of the separate apparatus.

In some circumstances, it may be desirable to determine whether a separate apparatus is proximate to the apparatus, whether a separate apparatus is proximate to another separate apparatus, and/or the like. For example, a user may desire to share location information with the other user by way of the user's apparatus when the user is proximate to the other user, when the user's apparatus is proximate to the other user's apparatus, and/or the like. In such circumstances, the separate apparatus property may be separate apparatus proximity information that indicates whether the separate apparatus is proximate to the apparatus, to another separate apparatus, and/or the like. In at least one example embodiment, an apparatus receives separate apparatus location information that identifies a location of the separate apparatus. The separate apparatus location information may be received from memory, another separate apparatus, and/or the like. In such an example embodiment, determination of a separate apparatus property may comprise determination of separate apparatus proximity information. The separate apparatus proximity information may be based, at least in part, on the separate apparatus location information, and determination of the separate apparatus property may be based, at least in part, on the separate apparatus proximity information. In another example, the apparatus may receive separate apparatus proximity information. The separate apparatus proximity information may be received from memory, another separate apparatus, and/or the like. In such an example, the determination of the separate apparatus property may be based, at least in part, on the separate apparatus proximity information.

FIG. 3A is a diagram illustrating an apparatus and the environment surrounding the apparatus according to at least one example embodiment. The example of FIG. 3A illustrates apparatus 302 in relation to apparatus 304 and apparatus 306. As can be seen, apparatus 304 and apparatus 306 are located outside of region 303. As such, in the example of FIG. 3A, apparatus 302 may correspond with apparatus 251 of FIG. 2B, apparatus 252 of FIG. 2B, and/or the like. As such, region 303 may correspond with region 251 of FIG. 2B, region 252 of FIG. 2B, and/or the like. Region 303 may indicate a proximity-based communication range of apparatus 302, a separate apparatus proximity criteria associated with a location sharing group, and/or the like. Although the example of FIG. 3A depicts region 303 to be circular, the shape and/or configuration of region 303 may vary.

In many circumstances, a user may desire to restrict and/or limit access to a location sharing group. For example, the user may desire to limit inclusion in the location sharing group to friends of the user, to individuals that are proximate to the user, to other users that are socializing at a particular location, and/or the like. In this manner, the user may restrict access to location information that identifies the locations of apparatuses included in the location sharing group to pertinent and/or relevant individuals. As such, it may be desirable to selectively include a separate apparatus in a location sharing group based, at least in part, on one or more separate apparatus properties associated with the separate apparatus.

In many circumstances, it may be desirable to configure an apparatus to include a separate apparatus in a location sharing group based, at least in part, on satisfaction of one or more criteria, existence of one or more conditions, and/or the like. In at least one example embodiment, an apparatus determines whether a separate apparatus property satisfies a location sharing group inclusion criteria. For example, the apparatus may determine that the separate apparatus property satisfies a particular location sharing group inclusion criteria, fails to satisfy the particular location sharing group inclusion criteria, and/or the like. The location sharing group inclusion criteria may comprise a separate apparatus property criteria, a durational criteria, a location criteria, and/or the like. In at least one example embodiment, the location sharing group inclusion criteria comprises a separate apparatus property criteria. In such an example embodiment, the determination that the separate apparatus property satisfies the location group sharing criteria may comprise determination that the separate apparatus property satisfies the separate apparatus property criteria. For example, the separate apparatus property criteria may be associated with a particular separate apparatus property. The separate apparatus property criteria, for example, may comprise a separate apparatus proximity criteria, a social relationship criteria, and/or the like.

In some circumstances, it may be desirable to restrict inclusion in a particular location sharing group to a particular set of users, a particular set of user apparatuses, and/or the like. For example, a user may desire to share location information with the user's friends, and may desire to avoid sharing of such location information with individuals that are not friends of the user. In this manner, in at least one example embodiment, a separate apparatus property is a social relationship property. In such an example embodiment, the determination of the separate apparatus property comprises determination of the social relationship property based, at least in part, on the separate apparatus identity. For example, the apparatus may utilize existing data that indicates a social relationship between a user and another user. In such an example, the apparatus may utilize a contact list, a social media friend list, a social relationship verification service, and/or the like. Such information may be received from memory, a server, a social networking service, and/or the like. In at least one example embodiment, a separate apparatus property criteria comprises a social relationship criteria. In such an example embodiment, the determination that the separate apparatus property satisfies the separate apparatus property criteria may comprise determination that the social relationship property satisfies the social relationship criteria. For example, the social relationship property may indicate a social relationship distance, and the social relationship criteria may indicate a social relationship distance threshold. The social relationship distance may be a property that indicates a level of familiarity between a user and another user. For example, the user and the other user may be family, close friends, friends of a mutual friend, unfamiliar acquaintances, and/or the like. In such an example, the user may desire to share location information with individuals that the user is close to, is direct friends with, and/or the like. In this manner, the user may desire to share location information with the user's best friend, but may desire to preclude sharing of such location information with an acquaintance that the user briefly met at some point in the past. As such, the social relationship distance threshold may be associated with a threshold level of familiarity between the user and another user, a threshold number of interactions between the user and the other user, a threshold number of social networking connections between the user and the other user, a threshold number of previous communications between the user and the other user, and/or the like. In such an example, the determination that the social relationship property satisfies the social relationship criteria may comprise determination that the social relationship distance is within the social relationship distance threshold.

In some circumstances, it may be desirable to restrict inclusion in a particular location sharing group to separate apparatuses that are proximate to an apparatus, apparatuses that are near to each other, and/or the like. For example, a user may desire to share location information with individuals that are proximate to the user, and may desire to avoid sharing of such location information with individuals that are not proximate to the user. In this manner, in at least one example embodiment, a separate apparatus property comprises separate apparatus proximity information. In such an example embodiment, a separate apparatus property criteria may comprise a separate apparatus proximity criteria. In such an example embodiment, the determination that the separate apparatus property satisfies the separate apparatus property criteria may comprise determination that the separate apparatus proximity information satisfies the separate apparatus proximity criteria. For example, the separate apparatus proximity criteria may comprise a proximity-based communication availability criteria, and the separate apparatus proximity information may comprise information indicative of proximity-based communication availability. In such an example, the determination that the separate apparatus property satisfies the separate apparatus property criteria may comprise determination that the information indicative of proximity-based communication availability corresponds with the proximity-based communication availability criteria.

The proximity-based communication availability criteria may designate availability of a proximity-based communication channel between a separate apparatus and another separate apparatus, between a separate apparatus and the apparatus, and/or the like. For example, the information indicative of proximity-based communication availability may indicate whether a proximity-based communication channel exists between a separate apparatus and another separate apparatus, between a separate apparatus and the apparatus, and/or the like. In at least one example embodiment, the determination that the information indicative of proximity-based communication availability corresponds with the proximity-based communication availability criteria comprises determination that the proximity-based communication channel designated by the proximity-based communication availability criteria corresponds with the proximity-based communication channel indicated by the information indicative of the proximity-based communication availability. The availability of a proximity-based communication channel and the determination of proximity based, at least in part, on the availability of a proximity-based communication channel may be similar as described regarding FIGS. 2A-2B.

The example of FIG. 3A illustrates apparatus 302 in relation to apparatus 304 and apparatus 306. As can be seen, apparatus 304 and apparatus 306 are located outside of region 303. As discussed previously, region 303 may indicate a proximity-based communication range of apparatus 302, a separate apparatus proximity criteria associated with a location sharing group, and/or the like. In this manner, apparatus 304 and apparatus 306 may fail to be proximate to apparatus 302. As such, in at least one example embodiment, apparatus 302 precludes establishment of a location sharing group that includes apparatus 304, apparatus 306, and/or the like, based, at least in part, on the location of apparatus 304 outside of region 303, the position of apparatus 306 beyond region 303, and/or the like.

FIG. 3B is a location sharing group according to at least one example embodiment. The example of FIG. 3B illustrates apparatus 302 in relation to apparatus 304 and apparatus 306, and corresponds with the example of FIG. 3A subsequent to relocation of apparatus 304 to a location within region 303. As can be seen, apparatus 306 remains at a position outside of region 303. As such, in the example of FIG. 3B, apparatus 302 may correspond with apparatus 201 of FIG. 2A, and apparatus 304 may correspond with apparatus 202 of FIG. 2A. Similarly, apparatus 302 may correspond with apparatus 251 of FIG. 2B and apparatus 306 may correspond with apparatus 252 of FIG. 2B. As can be seen in the example of FIG. 3B, apparatus 304 is at a position within region 303. As such, apparatus 304 may be within a proximity-based communication range of apparatus 302, a separate apparatus proximity criteria associated with a location sharing group, and/or the like. As such, in at least one example embodiment, apparatus 302 causes establishment of a location sharing group that includes apparatus 304, excludes apparatus 306, and/or the like, based, at least in part, on the location of apparatus 304 within of region 303, the position of apparatus 306 beyond region 303, and/or the like.

As discussed previously, in some circumstances, it may be desirable to share location information when the user is at a particular location. For example, the user may desire to share such location information when the user is at a fair grounds, at a local restaurant, walking through the mall, at an amusement park, and/or the like. When the user is at such locations, the user may desire to share location information associated with the user and the user's electronic apparatus with friends that may also be at the location with them. As such, in at least one example embodiment, an apparatus receives separate apparatus location information that identifies a location of the separate apparatus. In such an example embodiment, the location sharing group inclusion criteria may comprise a location criteria and a separate apparatus property criteria. In such an example embodiment, the determination that the separate apparatus property satisfies the location group criteria may comprise determination that the separate apparatus property satisfies the separate apparatus property criteria, and determination that a location associated with the location criteria is within a location distance threshold from the location of the separate apparatus. The location criteria may specify a particular location, a specific geographic region, and/or the like. For example, the location criteria may specify that the user is at a musical venue, is within fairground boundaries, and/or the like.

In some circumstances, a user may briefly encounter a friend on the street, in a restaurant, and/or the like. In such circumstances, the user may speak to the friend, visit with the friend, and/or the like. Although the user may be proximate to the friend, the user may not be socializing with the friend for an extended period of time, may not have extended plans with the friend, and/or the like. As such, the user may desire to avoid sharing location information with the friend notwithstanding the user's proximity to the friend, the user's presence in the restaurant, and/or the like. As such, it may be desirable to establish a location sharing group once a user has been proximate to the user's friend for a predetermined amount of time, for a configurable duration, and/or the like.

In at least one example embodiment, a location sharing group inclusion criteria comprises a durational criteria and a separate apparatus property criteria. In such an example embodiment, the determination that the separate apparatus property satisfies the location group criteria may comprise determination that the separate apparatus property satisfies the separate apparatus property criteria, and determination that a threshold duration associated with the durational criteria has elapsed subsequent to the determination that the separate apparatus property satisfies the separate apparatus property criteria. The determination that the threshold duration has elapsed subsequent to the determination that the separate apparatus property satisfies the separate apparatus property criteria may comprise determination that the threshold duration has elapsed subsequent to the determination that the separate apparatus property satisfies the separate apparatus property criteria. In such an example, the apparatus may determine that the threshold duration has elapsed absent a determination that the separate apparatus property has changed in a manner that causes the separate apparatus property to fail to satisfy the separate apparatus criteria. For example, the threshold duration may be satisfied once the apparatus has been proximate to the separate apparatus for 30 minutes. In such an example, if the apparatus becomes non-proximate to the separate apparatus prior to the elapse of the 30 minute threshold duration, the duration may reset. In this manner, the threshold duration may be non-cumulative. As such, threshold duration may specify that the apparatus remain proximate to the separate apparatus for the entire period indicated by the threshold duration.

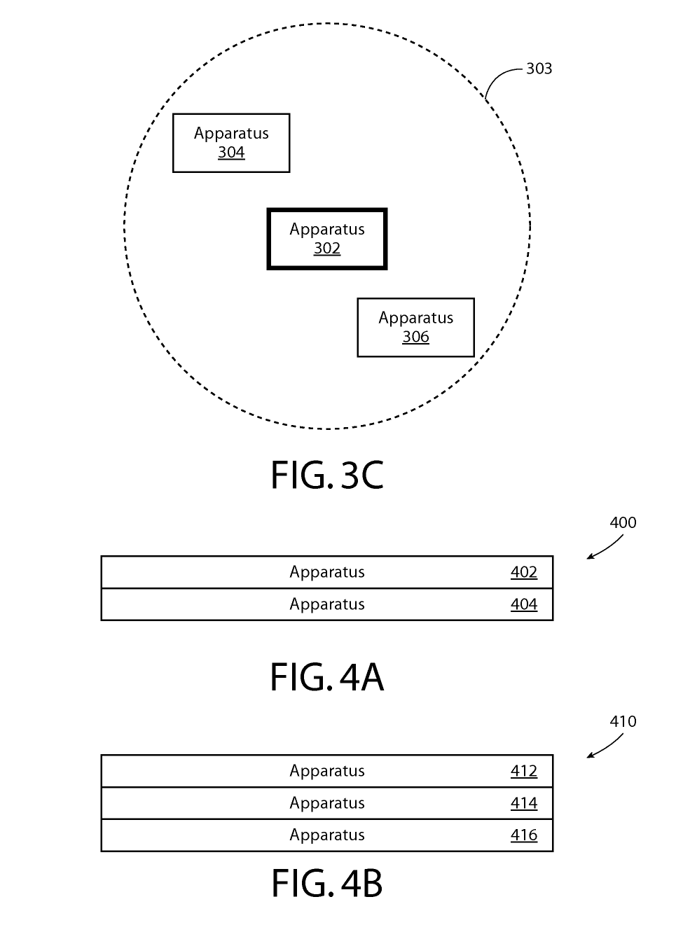

As discussed previously, in many circumstances, it may be desirable to establish a location sharing group that includes an apparatus, a separate apparatus, and/or the like. In at least one example embodiment, an apparatus causes establishment of a location sharing group that includes the separate apparatus. In such an example embodiment, establishment of the location sharing group may be based, at least in part, on the determination that a separate apparatus property associated with the separate apparatus satisfies one or more location sharing group inclusion criteria. Establishment of the location sharing group may be similar as described regarding FIGS. 4A-4B.

In some circumstances, it may be desirable to include a particular separate apparatus in a location sharing group based, at least in part, on receipt of consent from the separate apparatus, from a user of the separate apparatus, and/or the like. For example, a user of a separate apparatus may desire to control access to location information that indicates a location of the user's separate apparatus, to retain control over certain aspects of the user's privacy, and/or the like. As such, it may be desirable to communicate a desire to cause establishment of a location sharing group that includes the user's separate apparatus to the user of the separate apparatus. In at least one example embodiment, an apparatus sends a location sharing group invitation to the separate apparatus based, at least in part, on a determination that a separate apparatus property satisfies a location sharing group inclusion criteria. In such an example embodiment, the location sharing group invitation may be automatically generated and/or sent to the separate apparatus based, at least in part, on the determination that the separate apparatus property associated with the separate apparatus satisfies the location sharing group inclusion criteria. In such an example embodiment, the apparatus may receive a location sharing group acceptance from the separate apparatus. In such an example, the causation of establishment of the location sharing group that includes the separate apparatus may be based, at least in part, on the receipt of the location sharing group acceptance from the separate apparatus. In this manner, the user of the separate apparatus may indicate consent to provide location information to the apparatus via acceptance of the location sharing group invitation.

FIG. 3C is a location sharing group according to at least one example embodiment. The example of FIG. 3C illustrates apparatus 302 in relation to apparatus 304 and apparatus 306, and corresponds with the example of FIG. 3B subsequent to relocation of apparatus 306 to a location within region 303. As such, in the example of FIG. 3C, apparatus 302 may correspond with apparatus 201 of FIG. 2A, and apparatus 306 may correspond with apparatus 202 of FIG. 2A. As can be seen in the example of FIG. 3C, apparatus 306 is at a position within region 303. As such, apparatus 306 may be within a proximity-based communication range of apparatus 302, a separate apparatus proximity criteria associated with a location sharing group, and/or the like. In the example of FIG. 3C, apparatus 302 and/or a separate apparatus, such as a location service or a server, may communicate a location sharing group invitation to apparatus 306 based, at least in part, on satisfaction of one or more location sharing group inclusion criteria. For example, the location of apparatus 306 within region 303 may cause sending of such a location sharing group invitation to apparatus 306. In the example of FIG. 3C, the user of apparatus 306 may indicate a desire to join the location sharing group by way of sending of a location sharing group acceptance. In this manner, apparatus 302 and/or a separate apparatus, such as a location service or a server, may receive information indicative of the location sharing group acceptance, and cause establishment of a location sharing group that includes apparatus 306, modification of a location sharing group such that the location sharing group includes apparatus 306, and/or the like.

Similarly, in some circumstances, it may be desirable to allow a user of a particular separate apparatus to opt out of inclusion in a specific location sharing group. For example, the user may desire to avoid sharing location information with the specific location sharing group, may desire to keep the user's location private, may desire to discontinue sharing of such location information with the location sharing group and/or the like. As such, it may be desirable to communicate a desire to preclude establishment of a location sharing group that includes the user's separate apparatus, to remove the separate apparatus from the location sharing group, and/or the like. In at least one example embodiment, an apparatus receives information indicative of a location sharing group exclusion request from a separate apparatus. In such an example embodiment, the apparatus may cause modification of the location sharing group such that the location sharing group fails to include the separate apparatus, excludes the separate apparatus, and/or the like, based, at least in part, on the location sharing group exclusion request.

As discussed previously, in many circumstances, it may be desirable to communicate location information between apparatuses included in a particular location sharing group by way of the location sharing group. In at least one example embodiment, an apparatus causes communication of location information with a separate apparatus based, at least in part, on the location sharing group. The causation of communication of location information with the separate apparatus may comprise receipt of location information from the separate apparatus, sending of location information to the separate apparatus, and/or the like. In such circumstances, in order to facilitate communication of such location information, it may be desirable to determine a location of an apparatus, a separate apparatus, and/or the like. In at least one example embodiment, an apparatus determines apparatus location information that indicates a location of the apparatus. In such an example embodiment, the causation of communication of location information with the separate apparatus may comprise sending of the apparatus location information to the separate apparatus. In at least one example embodiment, an apparatus determines separate apparatus location information that indicates a location of separate apparatus, other separate apparatus location information that indicates a location of another separate apparatus, and/or the like. In such an example embodiment, the causation of communication of location information with the separate apparatus may comprise sending of the other apparatus location information to the separate apparatus. In this manner, communication of location information may comprise receipt of location information, sending of location information, and/or the like, amongst the apparatus, a separate apparatus, another separate apparatus, and/or the like.

In many circumstances, it may be desirable to modify an existing location sharing group. For example, it may be desirable to add an apparatus to the location sharing group, to remove an apparatus from the location sharing group, and/or the like. For example, a location sharing group may be established such that the location sharing group includes a separate apparatus. In such an example, it may be desirable to permit another separate apparatus to join the location sharing group based, at least in part, on satisfaction of location sharing group inclusion criteria associated with the location sharing group. As such, an apparatus may determine at least one other separate apparatus property of another separate apparatus, and determine that the other separate apparatus property satisfies the location sharing group inclusion criteria. In such an example, the apparatus may cause modification of the location sharing group such that the location sharing group includes the other separate apparatus based, at least in part, on the determination that the other separate apparatus property satisfies the location sharing group inclusion criteria. Subsequent to modification of the location sharing group to include the other separate apparatus, the apparatus may cause communication of location information with the other separate apparatus based, at least in part, on the location sharing group.

In another example, the apparatus may determine at least one other separate apparatus property of another separate apparatus, and determine that the other separate apparatus property fails to satisfy the location sharing group inclusion criteria. In such an example, the apparatus may preclude modification of the location sharing group such that the location sharing group includes the other separate apparatus based, at least in part, on the determination that the other separate apparatus property fails to satisfy the location sharing group inclusion criteria. In other words, the apparatus may cause modification of the location sharing group such that the location sharing group excludes the other separate apparatus based, at least in part, on the determination that the other separate apparatus property fails to satisfy the location sharing group inclusion criteria. In this manner, a separate apparatus that fails to satisfy location sharing group inclusion criteria may be precluded from inclusion in the location sharing group, precluded from communication of location information by way of the location sharing group, precluded from receipt of location information communicated another apparatus that is included in the location sharing group, and/or the like. In this manner, the apparatus may preclude communication of location information with the other separate apparatus based, at least in part, on the location sharing group.

In some circumstances, a separate apparatus that previously satisfied a particular location sharing group inclusion criteria may subsequently fail to satisfy the particular location sharing group inclusion criteria. In such circumstances, it may be desirable to remove the separate apparatus from the location sharing group, it exclude the separate apparatus from the location sharing group, to preclude communication of location information with the separate apparatus, and/or the like. In at least one example embodiment, an apparatus determines that a separate apparatus property no longer satisfies the location sharing group inclusion criteria. In such an example embodiment, the apparatus may cause modification of the location sharing group such that the location sharing group fails to include the separate apparatus, excludes the separate apparatus, and/or the like. Such modification of the location sharing group may be based, at least in part, on the determination that the separate apparatus property fails to satisfy the location sharing group inclusion criteria. In such an example embodiment, the apparatus may preclude communication of location information with the separate apparatus based, at least in part, on the location sharing group.

For example, as depicted in FIG. 3C, apparatus 302 may be proximate to apparatus 304 and apparatus 306. In such an example, apparatus 306 may be repositioned such that the position of apparatus 306 corresponds with the example of FIG. 3B. In other words, apparatus 306 may be moved to a position that is beyond region 303, to a position that is no longer proximate to apparatus 302, and/or the like. As such, it may be desirable to cause modification of a location sharing group such that the location sharing group no longer includes apparatus 306, excludes apparatus 306, and/or the like.

In some circumstances, it may be desirable to remove a separate apparatus from a location sharing group based, at least in part, on criteria that is independent of location sharing group inclusion criteria. For example, a particular location sharing group inclusion criteria may specify inclusion of a separate apparatus that is within 100 feet of an apparatus. In such an example, a group of friends may congregate at an individual's house prior to driving to a music festival, and a location sharing group may be established such that location information associated with the friends' apparatuses is communicated amongst members of the location sharing group. In such an example, the group of friends may drive separately to the music festival, and may freely roam around the geographic region associated with the music festival. As such, the friends may desire to continue communication of location information amongst the location sharing group despite being separated by more than 100 feet. In this manner, it may be desirable to allow for the configuration of location sharing group exclusion criteria that is independent of location sharing group inclusion criteria.

In at least one example embodiment, an apparatus determines that the separate apparatus property satisfies a location sharing group exclusion criteria. In such an example embodiment, the apparatus may cause modification of the location sharing group such that the location sharing group fails to include the separate apparatus, excludes the separate apparatus, and/or the like. In such an example, the modification of the location sharing group may be based, at least in part, on the determination that the separate apparatus property satisfies the location sharing group exclusion criteria. In such an example embodiment, the apparatus may preclude communication of location information with the separate apparatus based, at least in part, on the location sharing group. For example, the location sharing group exclusion criteria may comprise a separate apparatus property criteria, a durational criteria, a location criteria, and/or the like. The separate apparatus property criteria may comprise a separate apparatus proximity criteria or a social relationship criteria. For example, a location sharing group may be associated with location sharing group inclusion criteria that comprises separate apparatus proximity criteria and durational criteria that indicates that an apparatus be within 100 feet from a separate apparatus for a duration of 30 minutes. In such an example, the location sharing group may be associated with location sharing group exclusion criteria that comprises different separate apparatus proximity criteria and different durational criteria that indicates that an apparatus be further than 1 mile from the separate apparatus for a duration of 5 minutes. In this manner, once the location sharing group has been established by way of satisfaction of location sharing group inclusion criteria, the location sharing group may be modified based, at least in part, on satisfaction of location sharing group exclusion criteria that is independent of the location sharing group inclusion criteria.

FIGS. 4A-4B are diagrams illustrating a location sharing group data structure according to at least one example embodiment. The examples of FIGS. 4A-4B are merely examples and do not limit the scope of the claims. For example, location sharing group data structure configuration may vary, location sharing group data structure content may vary, location sharing group data structure size may vary, and/or the like.

In order to facilitate communication of location information amongst apparatuses included in a location sharing group, it may be desirable to store information that enables such communication in a location sharing group data structure. In at least one example embodiment, the causation of establishment of the location sharing group comprises causation of storage of information indicative of the separate apparatus in a location sharing group data structure. In such an example embodiment, the information indicative of the separate apparatus may enable communication of location information with a separate apparatus, another separate apparatus, amongst the members of the location sharing group, and/or the like. The information indicative of the separate apparatus may be associated with an identity of the separate apparatus, an address of the separate apparatus, a handle of the separate apparatus, a communication identifier of the separate apparatus, a communication address of the separate apparatus, and/or the like. Upon establishment of a location sharing group that includes a separate apparatus and/or modification of a location sharing group such that the location sharing group includes the separate apparatus, the apparatus may cause storage of information indicative of the separate apparatus in such a location sharing group data structure. The causation of storage of information indicative of the separate apparatus in the location sharing group data structure may comprise storage of the information indicative of the separate apparatus in a repository, a database, a memory, and/or the like. For example, the causation of storage of information indicative of the separate apparatus in the location sharing group data structure may comprise sending of the information indicative of the separate apparatus to a different separate apparatus such that the different separate apparatus stores the information indicative of the separate apparatus in the location sharing group data structure.

For example, the location sharing group including the separate apparatus may be associated with the location sharing group data structure comprising information indicative of the separate apparatus. Similarly, the causation of modification of the location sharing group to include the separate apparatus may comprise storage of information indicative of the separate apparatus in the location sharing group data structure. In another example, the location sharing group excluding the separate apparatus may be associated with the location sharing group data structure failing to comprise information indicative of the separate apparatus. Similarly, the causation of modification of the location sharing group to exclude the separate apparatus may comprise removal of the information indicative of the separate apparatus from the location sharing group data structure. Removal of the information indicative of the separate apparatus from the location sharing group data structure may comprise deletion of the information indicative of the separate apparatus from the location sharing group data structure.

FIG. 4A is a diagram illustrating a location sharing group data structure according to at least one example embodiment. The example of FIG. 4A illustrates location sharing group data structure 400, which comprises information indicative of apparatus 402 and apparatus 404. As such, the location sharing group indicated by location sharing group data structure 400 includes apparatus 402 and apparatus 404. The example of FIG. 4A may correspond with the scenario depicted in the example of FIG. 3B, FIG. 3C, and/or the like. For example, apparatus 402 may indicate apparatus 302 of FIG. 3B and apparatus 404 may indicate apparatus 304 of FIG. 3B. In another example, apparatus 402 may indicate apparatus 304 of FIG. 3C and apparatus 404 may indicate apparatus 306 of FIG. 3C. In this manner, for example, the location sharing group indicated by location sharing group data structure 400 may include apparatus 302 and apparatus 304 of FIG. 3B. In another example, the location sharing group indicated by location sharing group data structure 400 may include apparatus 304 and apparatus 306 of FIG. 3C.

FIG. 4B is a diagram illustrating a location sharing group data structure according to at least one example embodiment. The example of FIG. 4B illustrates location sharing group data structure 410, which comprises information indicative of apparatus 412, apparatus 414, and apparatus 416. As such, the location sharing group indicated by location sharing group data structure 410 includes apparatus 412, apparatus 414, and apparatus 416. The example of FIG. 4B may correspond with the scenario depicted in the example of FIG. 3C. For example, apparatus 412, apparatus 414, and apparatus 416 may indicate apparatus 302, apparatus 304, and apparatus 306 of FIG. 3C, respectively. In this manner, for example, the location sharing group indicated by location sharing group data structure 410 may include apparatus 302, apparatus 304, and apparatus 306 of FIG. 3C.

As can be seen, location sharing group data structure 400 of FIG. 4A comprises information indicative of two apparatuses, and location sharing group data structure 410 of FIG. 4B comprises information indicative of three apparatuses. In this manner, location sharing group data structure 410 of FIG. 4B may correspond with location sharing group data structure 400 of FIG. 4A subsequent to the inclusion of another separate apparatus to the location sharing group indicated by location sharing group data structure 410 of FIG. 4B. Similarly, location sharing group data structure 400 of FIG. 4A may correspond with location sharing group data structure 410 of FIG. 4B subsequent to the exclusion and/or removal of another separate apparatus from the location sharing group indicated by location sharing group data structure 400 of FIG. 4A.

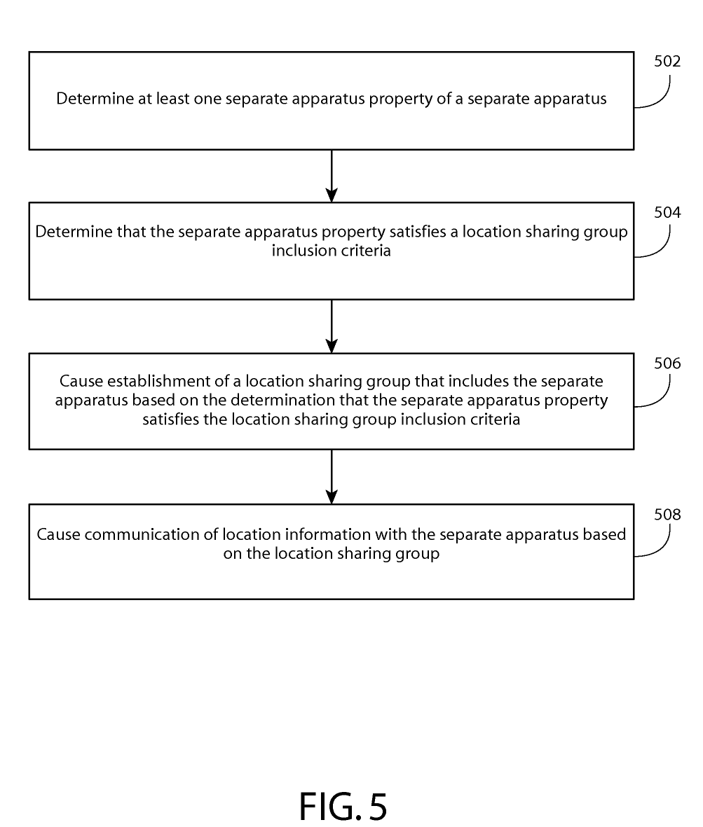

FIG. 5 is a flow diagram illustrating activities associated with causation of communication of location information with a separate apparatus according to at least one example embodiment. In at least one example embodiment, there is a set of operations that corresponds with the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 5.

At block 502, the apparatus determines at least one separate apparatus property of a separate apparatus. The determination, the separate apparatus, and the separate apparatus property may be similar as described regarding FIGS. 2A-2B and FIGS. 3A-3C.

At block 504, the apparatus determines that the separate apparatus property satisfies a location sharing group inclusion criteria. The determination and the location sharing group inclusion criteria may be similar as described regarding FIGS. 2A-2B and FIGS. 3A-3C.

At block 506, the apparatus causes establishment of a location sharing group that includes the separate apparatus based, at least in part, on the determination that the separate apparatus property satisfies the location sharing group inclusion criteria. The causation of establishment and the location sharing group may be similar as described regarding FIGS. 2A-2B, FIGS. 3A-3C, and FIGS. 4A-4B.

At block 508, the apparatus causes communication of location information with the separate apparatus based, at least in part, on the location sharing group. The causation of communication and the location information may be similar as described regarding FIGS. 2A-2B, FIGS. 3A-3C, and FIGS. 4A-4B.

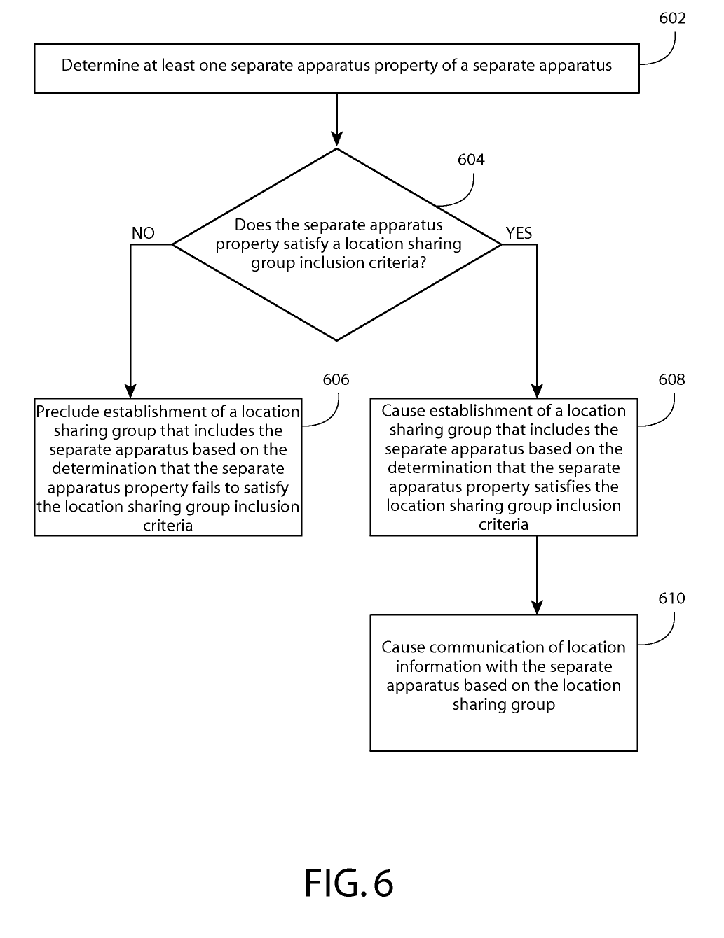

FIG. 6 is a flow diagram illustrating activities associated with determination of whether a separate apparatus property satisfies a location sharing group inclusion criteria according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

As discussed previously, in many circumstances, it may be desirable to determine whether a separate apparatus property satisfies a location sharing group inclusion criteria. In circumstances in which the apparatus determines that the separate apparatus property satisfies a location sharing group inclusion criteria, it may be desirable to cause establishment of a location sharing group that includes the separate apparatus. In circumstances in which the apparatus determines that the separate apparatus property fails to satisfy a location sharing group inclusion criteria, it may be desirable to preclude establishment of a location sharing group that includes the separate apparatus. For example, the apparatus may preclude inclusion of the separate apparatus in a previously established location sharing group based, at least in part, on the determination that the separate apparatus property fails to satisfy the location sharing group inclusion criteria.

At block 602, the apparatus determines at least one separate apparatus property of a separate apparatus. The determination, the separate apparatus, and the separate apparatus property may be similar as described regarding FIGS. 2A-2B and FIGS. 3A-3C.

At block 604, the apparatus determines whether the separate apparatus property satisfies a location sharing group inclusion criteria. If the apparatus determines that the separate apparatus property satisfies a location sharing group inclusion criteria, flow proceeds to block 608. If the apparatus determines that the separate apparatus property fails to satisfy a location sharing group inclusion criteria, flow proceeds to block 606. The determination and the location sharing group inclusion criteria may be similar as described regarding FIGS. 2A-2B and FIGS. 3A-3C.

At block 606, the apparatus precludes establishment of a location sharing group that includes the separate apparatus based, at least in part, on the determination that the separate apparatus property fails to satisfy the location sharing group inclusion criteria. The preclusion of establishment and the location sharing group may be similar as described regarding FIGS. 2A-2B, FIGS. 3A-3C, and FIGS. 4A-4B.

At block 608, the apparatus causes establishment of a location sharing group that includes the separate apparatus based, at least in part, on the determination that the separate apparatus property satisfies the location sharing group inclusion criteria. The causation of establishment and the location sharing group may be similar as described regarding FIGS. 2A-2B, FIGS. 3A-3C, and FIGS. 4A-4B.

At block 610, the apparatus causes communication of location information with the separate apparatus based, at least in part, on the location sharing group. The causation of communication and the location information may be similar as described regarding FIGS. 2A-2B, FIGS. 3A-3C, and FIGS. 4A-4B.

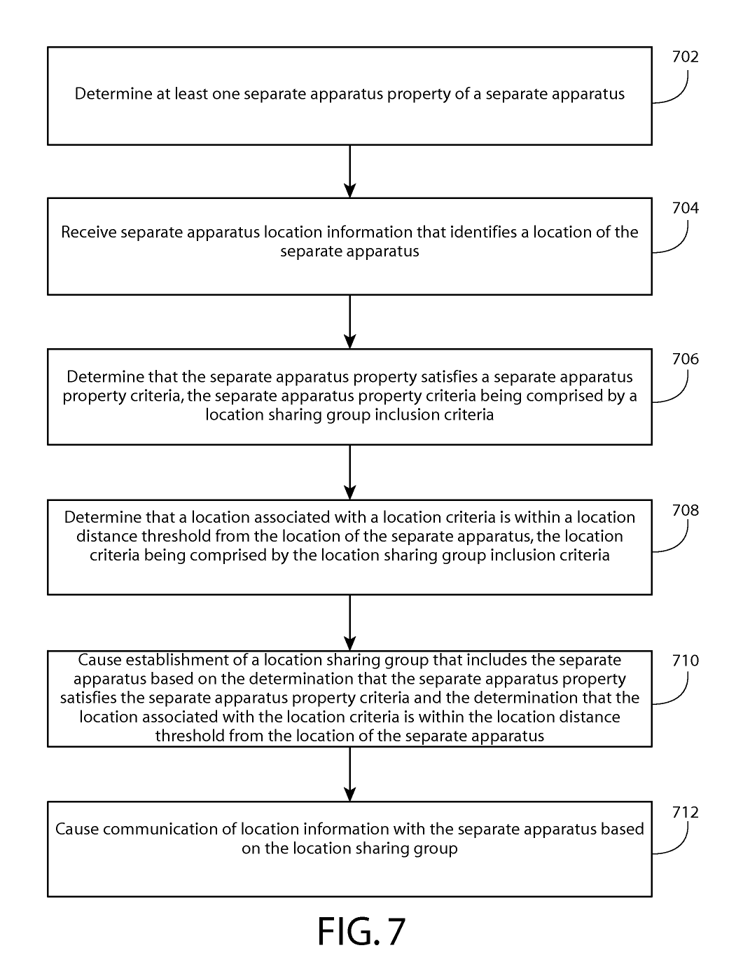

FIG. 7 is a flow diagram illustrating activities associated with causation of communication of location information with a separate apparatus according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

As discussed previously, in many circumstances, it may be desirable to cause establishment of a location sharing group that includes a separate apparatus based, at least in part, on a determination that a separate apparatus property of the separate apparatus satisfies a separate apparatus property criteria and a determination that a location associated with a location criteria is within a location distance threshold from the location of the separate apparatus.

At block 702, the apparatus determines at least one separate apparatus property of a separate apparatus. The determination, the separate apparatus, and the separate apparatus property may be similar as described regarding FIGS. 2A-2B and FIGS. 3A-3C.

At block 704, the apparatus receives separate apparatus location information that identifies a location of the separate apparatus. The receipt, the separate apparatus location information, and the location may be similar as described regarding FIGS. 2A-2B and FIGS. 3A-3C.

At block 706, the apparatus determines that the separate apparatus property satisfies a separate apparatus property criteria. In at least one example embodiment, the separate apparatus property criteria is comprised by a location sharing group inclusion criteria. The determination, the location sharing group inclusion criteria, and the separate apparatus property criteria may be similar as described regarding FIGS. 2A-2B and FIGS. 3A-3C.

At block 708, the apparatus determines that a location associated with a location criteria is within a location distance threshold from the location of the separate apparatus. In at least one example embodiment, the location criteria is comprised by the location sharing group inclusion criteria. The determination, the location, the location criteria, and the location distance threshold may be similar as described regarding FIGS. 2A-2B and FIGS. 3A-3C.

At block 710, the apparatus causes establishment of a location sharing group that includes the separate apparatus based, at least in part, on the determination that the separate apparatus property satisfies the separate apparatus property criteria and the determination that the location associated with the location criteria is within the location distance threshold from the location of the separate apparatus. The causation of establishment and the location sharing group may be similar as described regarding FIGS. 2A-2B, FIGS. 3A-3C, and FIGS. 4A-4B.

At block 712, the apparatus causes communication of location information with the separate apparatus based, at least in part, on the location sharing group. The causation of communication and the location information may be similar as described regarding FIGS. 2A-2B, FIGS. 3A-3C, and FIGS. 4A-4B.

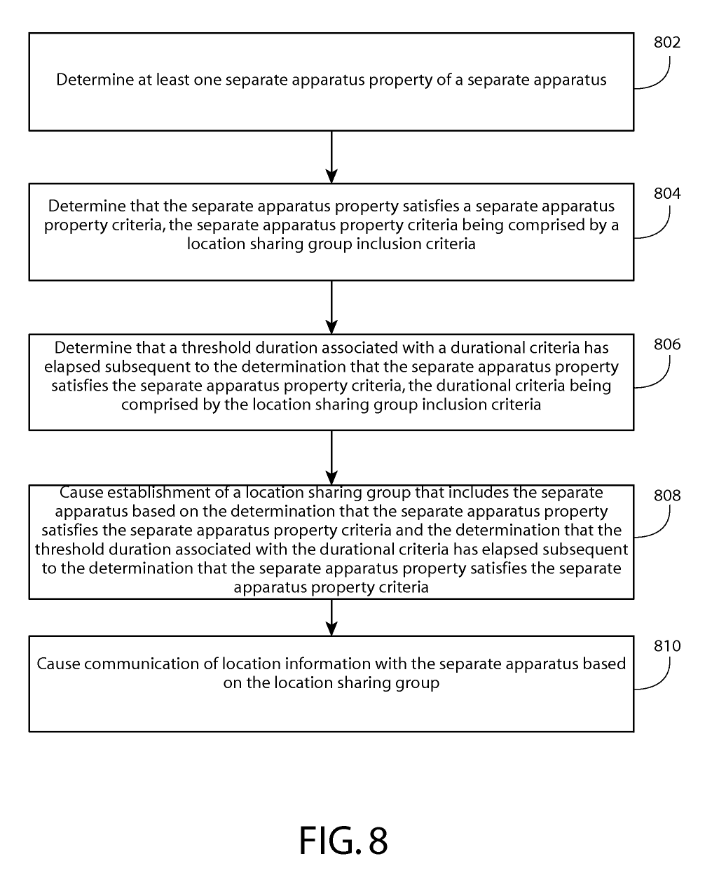

FIG. 8 is a flow diagram illustrating activities associated with causation of communication of location information with a separate apparatus according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

As discussed previously, in many circumstances, it may be desirable to cause establishment of a location sharing group that includes a separate apparatus based, at least in part, on a determination that a separate apparatus property of the separate apparatus satisfies a separate apparatus property criteria and a determination that a threshold duration associated with a durational criteria has elapsed subsequent to the determination that the separate apparatus property satisfies the separate apparatus property criteria.

At block 802, the apparatus determines at least one separate apparatus property of a separate apparatus. The determination, the separate apparatus, and the separate apparatus property may be similar as described regarding FIGS. 2A-2B and FIGS. 3A-3C.

At block 804, the apparatus determines that the separate apparatus property satisfies a separate apparatus property criteria. In at least one example embodiment, the separate apparatus property criteria is comprised by a location sharing group inclusion criteria. The determination, the location sharing group inclusion criteria, and the separate apparatus property criteria may be similar as described regarding FIGS. 2A-2B and FIGS. 3A-3C.

At block 806, the apparatus determines that a threshold duration associated with a durational criteria has elapsed subsequent to the determination that the separate apparatus property satisfies the separate apparatus property criteria. In at least one example embodiment, the durational criteria is comprised by the location sharing group inclusion criteria. The determination, the threshold duration, and the durational criteria may be similar as described regarding FIGS. 2A-2B and FIGS. 3A-3C.

At block 808, the apparatus causes establishment of a location sharing group that includes the separate apparatus based, at least in part, on the determination that the separate apparatus property satisfies the separate apparatus property criteria and the determination that the threshold duration associated with the durational criteria has elapsed subsequent to the determination that the separate apparatus property satisfies the separate apparatus property criteria. The causation of establishment and the location sharing group may be similar as described regarding FIGS. 2A-2B, FIGS. 3A-3C, and FIGS. 4A-4B.

At block 810, the apparatus causes communication of location information with the separate apparatus based, at least in part, on the location sharing group. The causation of communication and the location information may be similar as described regarding FIGS. 2A-2B, FIGS. 3A-3C, and FIGS. 4A-4B.

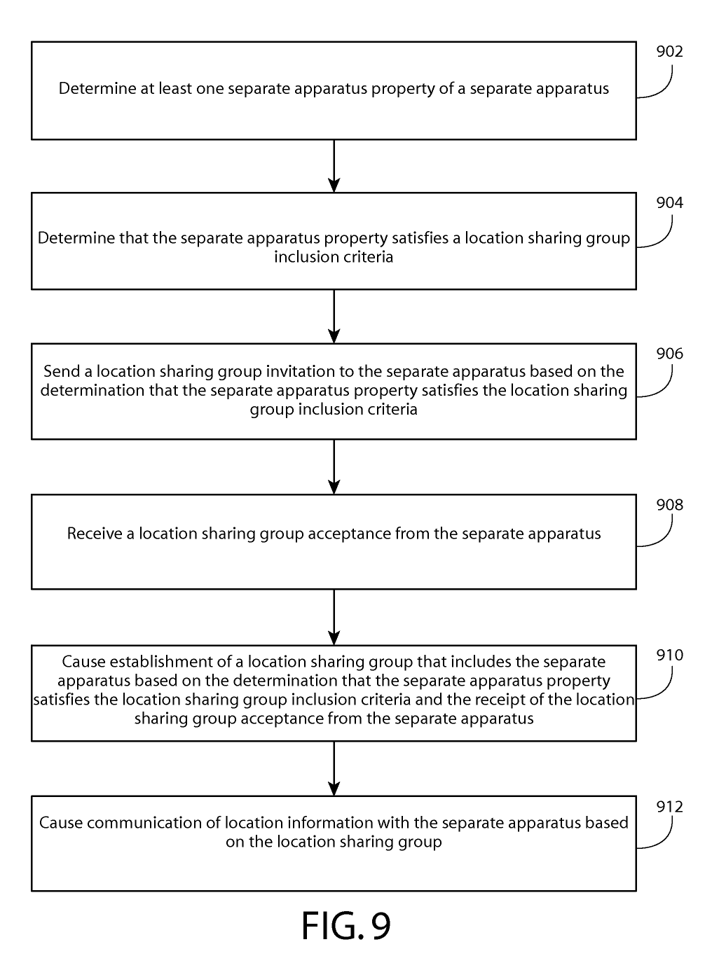

FIG. 9 is a flow diagram illustrating activities associated with causation of communication of location information with a separate apparatus according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As discussed previously, in some circumstances, it may be desirable to send a location sharing group invitation to the separate apparatus. In such circumstances, it may be desirable to causes establishment of a location sharing group that includes the separate apparatus based, at least in part, on receipt of a location sharing group acceptance associated with the location sharing group invitation from the separate apparatus.

At block 902, the apparatus determines at least one separate apparatus property of a separate apparatus. The determination, the separate apparatus, and the separate apparatus property may be similar as described regarding FIGS. 2A-2B and FIGS. 3A-3C.

At block 904, the apparatus determines that the separate apparatus property satisfies a location sharing group inclusion criteria. The determination and the location sharing group inclusion criteria may be similar as described regarding FIGS. 2A-2B and FIGS. 3A-3C.

At block 906, the apparatus sends a location sharing group invitation to the separate apparatus based, at least in part, on the determination that the separate apparatus property satisfies the location sharing group inclusion criteria. The sending and the location sharing group invitation may be similar as described regarding FIGS. 2A-2B and FIGS. 3A-3C.

At block 908, the apparatus receives a location sharing group acceptance from the separate apparatus. The receipt and the location sharing group acceptance may be similar as described regarding FIGS. 2A-2B and FIGS. 3A-3C.

At block 910, the apparatus causes establishment of a location sharing group that includes the separate apparatus based, at least in part, on the determination that the separate apparatus property satisfies the location sharing group inclusion criteria and the receipt of the location sharing group acceptance from the separate apparatus. The causation of establishment and the location sharing group may be similar as described regarding FIGS. 2A-2B, FIGS. 3A-3C, and FIGS. 4A-4B.

At block 912, the apparatus causes communication of location information with the separate apparatus based, at least in part, on the location sharing group. The causation of communication and the location information may be similar as described regarding FIGS. 2A-2B, FIGS. 3A-3C, and FIGS. 4A-4B.

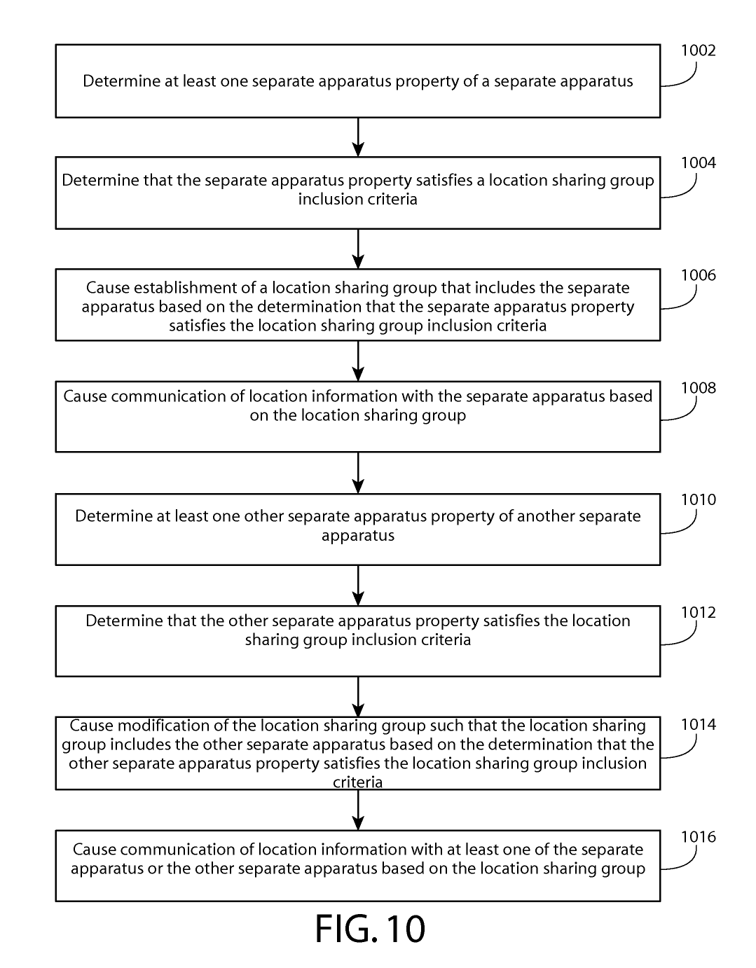

FIG. 10 is a flow diagram illustrating activities associated with causation of communication of location information with at least one of a separate apparatus or another separate apparatus according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

As discussed previously, in many circumstances, it may be desirable to cause modification of a location sharing group such that the location sharing group includes another separate apparatus, a different separate apparatus, and/or the like.

At block 1002, the apparatus determines at least one separate apparatus property of a separate apparatus. The determination, the separate apparatus, and the separate apparatus property may be similar as described regarding FIGS. 2A-2B and FIGS. 3A-3C.

At block 1004, the apparatus determines that the separate apparatus property satisfies a location sharing group inclusion criteria. The determination and the location sharing group inclusion criteria may be similar as described regarding FIGS. 2A-2B and FIGS. 3A-3C.

At block 1006, the apparatus causes establishment of a location sharing group that includes the separate apparatus based, at least in part, on the determination that the separate apparatus property satisfies the location sharing group inclusion criteria. The causation of establishment and the location sharing group may be similar as described regarding FIGS. 2A-2B, FIGS. 3A-3C, and FIGS. 4A-4B.

At block 1008, the apparatus causes communication of location information with the separate apparatus based, at least in part, on the location sharing group. The causation of communication and the location information may be similar as described regarding FIGS. 2A-2B, FIGS. 3A-3C, and FIGS. 4A-4B.

At block 1010, the apparatus determines at least one other separate apparatus property of another separate apparatus. The determination, the other separate apparatus, and the other separate apparatus property may be similar as described regarding FIGS. 2A-2B and FIGS. 3A-3C.

At block 1012, the apparatus determines that the other separate apparatus property satisfies the location sharing group inclusion criteria. The determination may be similar as described regarding FIGS. 2A-2B and FIGS. 3A-3C.

At block 1014, the apparatus causes modification of the location sharing group such that the location sharing group includes the other separate apparatus based, at least in part, on the determination that the other separate apparatus property satisfies the location sharing group inclusion criteria. The causation of modification of the location sharing group may be similar as described regarding FIGS. 2A-2B, FIGS. 3A-3C, and FIGS. 4A-4B.

At block 1016, the apparatus causes communication of location information with the separate apparatus based, at least in part, on the location sharing group. The causation of communication and the location information may be similar as described regarding FIGS. 2A-2B, FIGS. 3A-3C, and FIGS. 4A-4B.

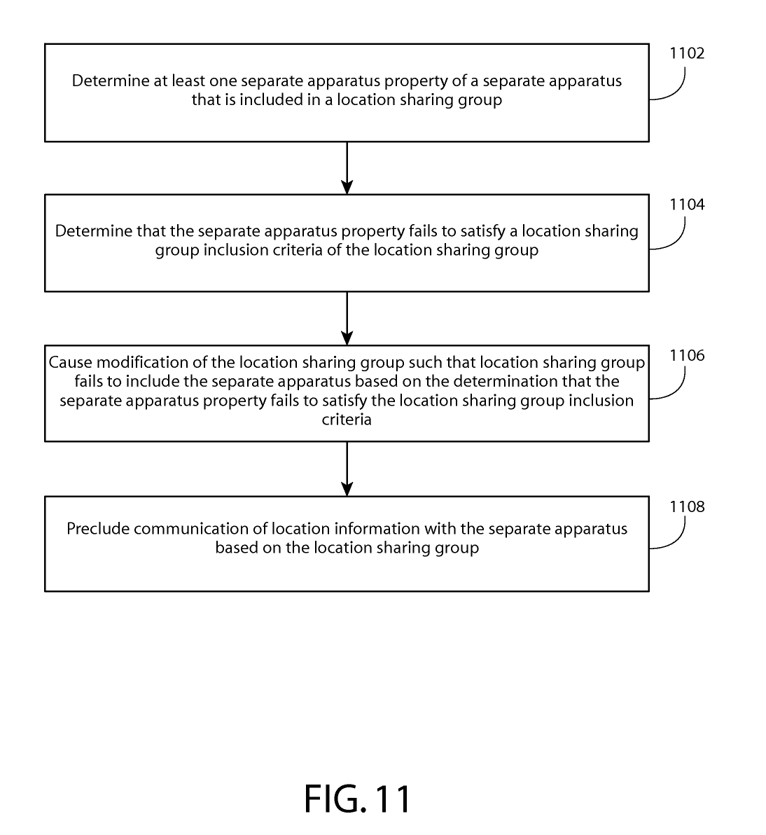

FIG. 11 is a flow diagram illustrating activities associated with preclusion of communication of location information with a separate apparatus according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

As discussed previously, in many circumstances, it may be desirable to modify a location sharing group such that the location sharing group fails to include a separate apparatus based, at least in part, on a determination that a separate apparatus property of the separate apparatus fails to satisfy a location sharing group inclusion criteria.

At block 1102, the apparatus determines at least one separate apparatus property of a separate apparatus that is included in a location sharing group. The determination, the separate apparatus, the separate apparatus property, and the location sharing group may be similar as described regarding FIGS. 2A-2B, FIGS. 3A-3C, and FIGS. 4A-4B.

At block 1104, the apparatus determines that the separate apparatus property fails to satisfy a location sharing group inclusion criteria of the location sharing group. The determination and the location sharing group inclusion criteria may be similar as described regarding FIGS. 2A-2B and FIGS. 3A-3C.

At block 1106, the apparatus causes modification of the location sharing group such that the location sharing group fails to include the separate apparatus based, at least in part, on the determination that the separate apparatus property fails to satisfy the location sharing group inclusion criteria. The causation of modification of the location sharing group may be similar as described regarding FIGS. 2A-2B, FIGS. 3A-3C, and FIGS. 4A-4B.

At block 1108, the apparatus precludes communication of location information with the separate apparatus based, at least in part, on the location sharing group. The preclusion of communication and the location information may be similar as described regarding FIGS. 2A-2B, FIGS. 3A-3C, and FIGS. 4A-4B.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 708 of FIG. 7 may be performed before block 706 of FIG. 7. Furthermore, if desired, one or more of the above-described functions may be optional or may be combined. For example, block 1108 of FIG. 11 may be optional and/or combined with block 1106 of FIG. 11.

Although various aspects of embodiments are set out in the claims, the summary, and the description, other aspects of the embodiments comprise other combinations of features from other described embodiments. In this manner, the embodiments include the combinations explicitly set out in the claims, the summary, and the description, as well as any other suitable combinations of any suitable features.

It is also noted herein that while the above describes example embodiments, these descriptions should not be viewed in a limiting sense. Rather, there are variations and modifications which may be made without departing from the scope of the present disclosure.

What is claimed is:

1. An apparatus, comprising:
at least one processor;
at least one memory including computer program code, the memory and the computer program code configured to, working with the processor, cause the apparatus to perform at least the following:
determination of at least one separate apparatus property of a separate apparatus;
determination that the separate apparatus property satisfies a location sharing group inclusion criteria;
causation of establishment of a location sharing group that includes the separate apparatus based, at least in part, on the determination that the separate apparatus property satisfies the location sharing group inclusion criteria; and
causation of communication of location information with the separate apparatus based, at least in part, on the location sharing group.

2. The apparatus of claim 1, wherein the memory includes computer program code configured to, working with the processor, cause the apparatus to perform receipt of separate apparatus location information that identifies a location of the separate apparatus, wherein the location sharing group inclusion criteria comprises a location criteria and a separate apparatus property criteria, and the determination that the separate apparatus property satisfies the location group criteria comprises:
determination that the separate apparatus property satisfies the separate apparatus property criteria; and
determination that a location associated with the location criteria is within a location distance threshold from the location of the separate apparatus.

3. The apparatus of claim 1, wherein the location sharing group inclusion criteria comprises a durational criteria and a separate apparatus property criteria, and the determination that the separate apparatus property satisfies the location group criteria comprises:
determination that the separate apparatus property satisfies the separate apparatus property criteria; and
determination that a threshold duration associated with the durational criteria has elapsed subsequent to the determination that the separate apparatus property satisfies the separate apparatus property criteria.

4. The apparatus of claim 1, wherein the memory includes computer program code configured to, working with the processor, cause the apparatus to perform:
sending of a location sharing group invitation to the separate apparatus based, at least in part, on the determination that the separate apparatus property satisfies the location sharing group inclusion criteria; and
receipt of a location sharing group acceptance from the separate apparatus, wherein the causation of establishment of the location sharing group that includes the separate apparatus is based, at least in part, on the receipt of the location sharing group acceptance from the separate apparatus.

5. The apparatus of claim 1, wherein the memory includes computer program code configured to, working with the processor, cause the apparatus to perform:
determination of at least one other separate apparatus property of another separate apparatus;
determination that the other separate apparatus property satisfies the location sharing group inclusion criteria;
causation of modification of the location sharing group such that the location sharing group includes the other separate apparatus based, at least in part, on the determination that the other separate apparatus property satisfies the location sharing group inclusion criteria; and
causation of communication of location information with the other separate apparatus based, at least in part, on the location sharing group.

6. The apparatus of claim 1, wherein the memory includes computer program code configured to, working with the processor, cause the apparatus to perform:
determination of at least one other separate apparatus property of another separate apparatus;
determination that the other separate apparatus property fails to satisfy the location sharing group inclusion criteria; and
preclusion of modification of the location sharing group such that the location sharing group includes the other separate apparatus based, at least in part, on the determination that the other separate apparatus property fails to satisfy the location sharing group inclusion criteria.

7. The apparatus of claim 1, wherein the memory includes computer program code configured to, working with the processor, cause the apparatus to perform:
determination that the separate apparatus property no longer satisfies the location sharing group inclusion criteria; and
causation of modification of the location sharing group such that the location sharing group fails to include the separate apparatus based, at least in part, on the determination that the separate apparatus property fails to satisfy the location sharing group inclusion criteria.

8. The apparatus of claim 1, wherein the memory includes computer program code configured to, working with the processor, cause the apparatus to perform:
determination that the separate apparatus property satisfies a location sharing group exclusion criteria; and
causation of modification of the location sharing group such that the location sharing group fails to include the separate apparatus based, at least in part, on the determination that the separate apparatus property satisfies the location sharing group exclusion criteria.

9. The apparatus of claim 1, wherein the apparatus comprises a communication device.

10. A method comprising:
determining at least one separate apparatus property of a separate apparatus;
determining that the separate apparatus property satisfies a location sharing group inclusion criteria;
causing establishment of a location sharing group that includes the separate apparatus based, at least in part, on the determination that the separate apparatus property satisfies the location sharing group inclusion criteria; and
causing communication of location information with the separate apparatus based, at least in part, on the location sharing group.

11. The method of claim 10, further comprising receiving separate apparatus location information that identifies a location of the separate apparatus, wherein the location sharing group inclusion criteria comprises a location criteria and a separate apparatus property criteria, and the determination that the separate apparatus property satisfies the location group criteria comprises:
determining that the separate apparatus property satisfies the separate apparatus property criteria; and
determining that a location associated with the location criteria is within a location distance threshold from the location of the separate apparatus.

12. The method of claim 10, wherein the location sharing group inclusion criteria comprises a durational criteria and a separate apparatus property criteria, and the determination that the separate apparatus property satisfies the location group criteria comprises:
determining that the separate apparatus property satisfies the separate apparatus property criteria; and
determining that a threshold duration associated with the durational criteria has elapsed subsequent to the determination that the separate apparatus property satisfies the separate apparatus property criteria.

13. The method of claim 10, further comprising:
determining at least one other separate apparatus property of another separate apparatus;
determining that the other separate apparatus property satisfies the location sharing group inclusion criteria;
causing modification of the location sharing group such that the location sharing group includes the other separate apparatus based, at least in part, on the determination that the other separate apparatus property satisfies the location sharing group inclusion criteria; and
causing communication of location information with the other separate apparatus based, at least in part, on the location sharing group.

14. The method of claim 10, further comprising:
determining at least one other separate apparatus property of another separate apparatus;
determining that the other separate apparatus property fails to satisfy the location sharing group inclusion criteria; and
precluding modification of the location sharing group such that the location sharing group includes the other separate apparatus based, at least in part, on the determination that the other separate apparatus property fails to satisfy the location sharing group inclusion criteria.

15. The method of claim 10, further comprising:
determining that the separate apparatus property no longer satisfies the location sharing group inclusion criteria; and
causing modification of the location sharing group such that the location sharing group fails to include the separate apparatus based, at least in part, on the determination that the separate apparatus property fails to satisfy the location sharing group inclusion criteria.

16. The method of claim 10, further comprising:
determining that the separate apparatus property satisfies a location sharing group exclusion criteria; and
causing modification of the location sharing group such that the location sharing group fails to include the separate apparatus based, at least in part, on the determination that the separate apparatus property satisfies the location sharing group exclusion criteria.

17. At least one computer-readable medium encoded with instructions that, when executed by a processor, perform:
determination of at least one separate apparatus property of a separate apparatus;
determination that the separate apparatus property satisfies a location sharing group inclusion criteria;
causation of establishment of a location sharing group that includes the separate apparatus based, at least in part, on the determination that the separate apparatus property satisfies the location sharing group inclusion criteria; and
causation of communication of location information with the separate apparatus based, at least in part, on the location sharing group.

18. The medium of claim 17, further encoded with instructions that, when executed by a processor, perform receipt of separate apparatus location information that identifies a location of the separate apparatus, wherein the location sharing group inclusion criteria comprises a location criteria and a separate apparatus property criteria, and the determination that the separate apparatus property satisfies the location group criteria comprises:
determination that the separate apparatus property satisfies the separate apparatus property criteria; and
determination that a location associated with the location criteria is within a location distance threshold from the location of the separate apparatus.

19. The medium of claim 17, wherein the location sharing group inclusion criteria comprises a durational criteria and a separate apparatus property criteria, and the determination that the separate apparatus property satisfies the location group criteria comprises:
determination that the separate apparatus property satisfies the separate apparatus property criteria; and
determination that a threshold duration associated with the durational criteria has elapsed subsequent to the determination that the separate apparatus property satisfies the separate apparatus property criteria.

20. The medium of claim 17, further encoded with instructions that, when executed by a processor, perform:
determination that the separate apparatus property no longer satisfies the location sharing group inclusion criteria; and
causation of modification of the location sharing group such that the location sharing group fails to include the separate apparatus based, at least in part, on the determination that the separate apparatus property fails to satisfy the location sharing group inclusion criteria.
